(19) United States
(12) Patent Application Publication
(10) Pub. No.: US 2026/0067742 A1
(43) Pub. Date: Mar. 5, 2026

(54) SYSTEMS AND METHODS WITH QUALITY OF SERVICE PARAMETERS RELATING TO LATENCY OF TRAFFIC FLOW

(71) Applicant: Meta Platforms Technologies, LLC, Menlo Park, CA (US)

(72) Inventors: Muhammad Kumail HAIDER, Sunnyvale, CA (US); Guoqing LI, Cupertino, CA (US)

(73) Assignee: Meta Platforms Technologies, LLC, Menlo Park, CA (US)

(21) Appl. No.: 19/280,506

(22) Filed: Jul. 25, 2025

Related U.S. Application Data
(60) Provisional application No. 63/690,263, filed on Sep. 3, 2024.

(51) Int. Cl. H04W 28/02; H04W 52/02; H04W 84/12

(52) U.S. Cl. CPC H04W 28/0268; H04W 52/0216; H04W 84/12

(57) ABSTRACT

A first device may include one or more processors. The one or more processors may generate a first frame including a set of quality of service (QoS) parameters of a traffic flow of the first device in a wireless local area network (WLAN). The set of QoS parameters may include a first field relating to latency of the traffic flow. The one or more processors may set the first field to indicate to a second device a request for availability of the second device during a time period associated with the traffic flow. The one or more processors may wirelessly transmit, via a transceiver to the second device, the first frame.

### CROSS-REFERENCE TO RELATED APPLICATION

This application claims priority to U.S. Provisional Patent Application No.: 63/690,263 filed on September 3, 2024, which is incorporated by reference herein in its entirety for all purposes.

### FIELD OF DISCLOSURE

The present disclosure is generally related to communications, including but not limited to, systems and methods with quality of service parameters relating to latency of a traffic flow.

### BACKGROUND

Artificial reality, such as a virtual reality (VR), an augmented reality (AR), or a mixed reality (MR), provides immersive experience to a user. In one example, a user wearing a head wearable display (HWD) can turn the user’s head to one side, and an image of a virtual object corresponding to a location and/or an orientation of the HWD and a gaze direction of the user can be displayed on the HWD to allow the user to feel as if the user is moving within a space of an artificial reality (e.g., a VR space, an AR space, or a MR space). An image of a virtual object may be generated by a computing device communicatively coupled to the HWD. In some embodiments, the computing device may have access to a network.

### SUMMARY

Various embodiments disclosed herein are related to a first device. The first device may include one or more processors. The one or more processors may generate a first frame including a set of quality of service (QoS) parameters of a traffic flow of the first device in a wireless local area network (WLAN). The set of QoS parameters may include a first field relating to latency of the traffic flow. The one or more processors may set the first field to indicate to a second device a request for availability of the second device during a time period associated with the traffic flow. The one or more processors may wirelessly transmit, via a transceiver to the second device, the first frame.

Various embodiments disclosed herein are related to a method. The method may include generating, by one or more processors of a first device, a first frame including a set of quality of service (QoS) parameters of a traffic flow of the first device in a wireless local area network (WLAN). The set of QoS parameters may include a first field relating to latency of the traffic flow. The method may include setting, by the one or more processors, the first field to indicate to a second device a request for availability of the second device during a time period associated with the traffic flow. The method may include wirelessly transmitting, via a transceiver to the second device, the first frame.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a timing diagram showing a wake-up/sleep schedule of a computing device utilizing TWT, according to an example implementation of the present disclosure.

FIG. 5A is an example format of a QoS element field, according to an example implementation of the present disclosure.

FIG. 5B is an example format of a control information field, according to an example implementation of the present disclosure.

FIG. 6 is an example format of a capability element field, according to an example implementation of the present disclosure.

FIG. 7 is a block diagram of an example system environment in which a client device and an access point communicate with each other data relating to QoS parameters, according to an example implementation of the present disclosure.

FIG. 8 is a flowchart showing a process associated with QoS parameters relating to latency of traffic flow, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Streams of traffic may be characterized by different types of traffic. For instance, an application may be characterized by latency sensitive traffic (e.g., video/voice (VI/VO), real time interactive applications, and the like) or regular traffic (e.g., best effort/background applications (BE/BK)). Latency sensitive traffic may be identifiable, in part, based on its bursty nature (e.g., periodic bursts of traffic), in some embodiments. For instance, video display traffic may be driven by a refresh rate of 60Hz, 72Hz, 90Hz, or 120Hz. An application and/or device may have combinations of traffic types (e.g., latency sensitive traffic and non-latency sensitive traffic). Further, each stream of traffic for the application and/or device may be more or less spontaneous and/or aperiodic as compared to the other streams of traffic for the application and/or device. Accordingly, traffic may vary according to applications and/or channel rate dynamics.

TWT can be a time agreed/negotiated upon by devices (e.g., access points (APs) and/or stations (STAs)), or specified/configured by one device (e.g., an AP). During the wake time, a first device (e.g., a STA) may be in an awake state (e.g., its wireless communication module/interface is in a fully powered-up ready, or wake state) and is able to transmit and/or receive. When the first device is not awake (e.g., its wireless communication module/interface is in a powered-down, low power, or sleep state), the first device may enter a low power mode or other sleep mode. The first device may exist in the sleep state until a time instance/window as specified by the TWT.

TWT is a mechanism where a set of service periods (SPs) are defined and shared between devices to reduce medium contention and improve the power efficiency of the devices. For example, the first device can wake up periodically (e.g., at a fixed, configured time interval/period/cycle) based on the TWT. The TWT reduces energy consumption of the devices by limiting the awake time and associated power consumption of the devices.

An AP (e.g., AP and/or other device operating as a soft AP/hotspot) may enhance medium access protection and resource reservation by supporting restricted TWT (R-TWT). The R-TWT SPs may be used to deliver latency sensitive traffic and/or any additional frame that supports latency sensitive traffic.

Latency sensitive traffic that is not prioritized (or protected) may degrade a user experience. For example, in an AR context, latency between a movement of a user wearing an AR device and an image corresponding to the user movement and displayed to the user using the AR device may cause judder, resulting in motion sickness.

In one implementation, an image of a virtual object is generated by a remote computing device communicatively coupled to the HWD, and the image is rendered by the HWD to conserve computational resources and/or achieve bandwidth efficiency. In one example, the HWD includes various sensors that detect a location and/or orientation of the HWD and a gaze direction of the user wearing the HWD, and transmits sensor measurements indicating the detected location and gaze direction to a console device (and/or a remote server, e.g., in the cloud) through a wired connection or a wireless connection. The console device can determine a user’s view of the space of the artificial reality according to the sensor measurements, and generate an image of the space of the artificial reality corresponding to the user’s view. The console device can transmit the generated image to the HWD, by which the image of the space of the artificial reality corresponding to the user’s view can be presented to the user. In one aspect, the process of detecting the location of the HWD and the gaze direction of the user wearing the HWD, and rendering the image to the user should be performed within a frame time (e.g., less than 11 ms). Any latency between a movement of the user wearing the HWD and an image displayed corresponding to the user movement can cause judder, which may result in motion sickness and can degrade the user experience.

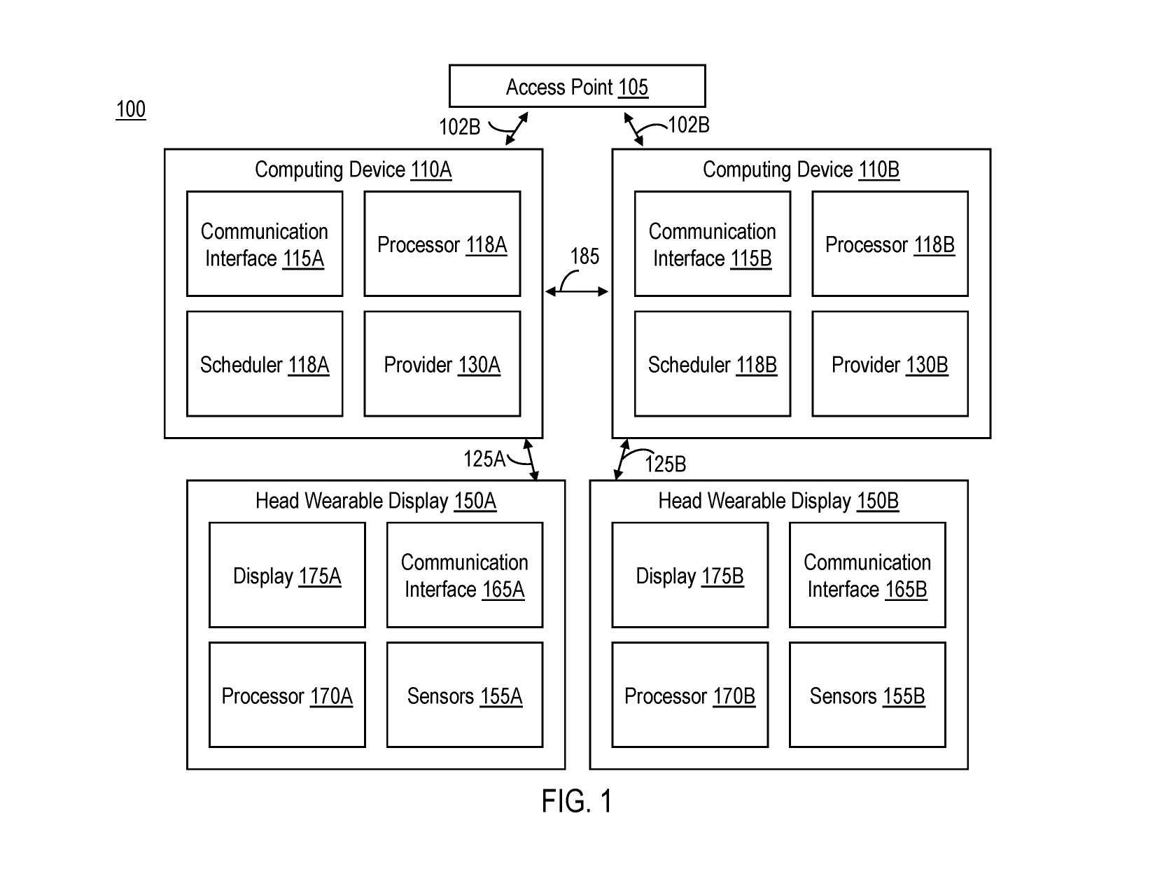

FIG. 1 is a block diagram of an example artificial reality system environment. FIG. 1 provides an example environment in which devices may communicate traffic streams with different latency sensitivities/requirements. In some embodiments, the artificial reality system environment 100 includes an access point (AP) 105, one or more head wearable displays (HWD) 150 (e.g., HWD 150A, 150B) worn by a user, and one or more computing devices 110 (computing devices 110A, 110B) providing content of artificial reality to the HWDs 150.

The access point 105 may be a router or any network device allowing one or more computing devices 110 and/or one or more HWDs 150 to access a network (e.g., the Internet). The access point 105 may be replaced by any communication device (cell site). A HWD may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the computing device 110 through a wired or wireless connection. The HWD 150 may also identify objects (e.g., body, hand face).

In some embodiments, the computing devices 110A, 110B communicate with the access point 105 through communication links 102A, 102B (e.g., interlinks), respectively. In some embodiments, the computing device 110A may communicate with the HWD 150A through a communication link 125A (e.g., intralink), and the computing device 110B may communicate with the HWD 150B through a wireless link 125B (e.g., intralink).

The computing device 110 may be a computing device or a mobile device that can retrieve content from the access point 105, and can provide image data of artificial reality to a corresponding HWD 150. Each HWD 150 may present the image of the artificial reality to a user according to the image data.

The computing device 110 may determine a view within the space of the artificial reality corresponding to the detected location, orientation and/or the gaze direction, and generate an image depicting the determined view detected by the HWD 150s. The computing device 110 may also receive one or more user inputs and modify the image according to the user inputs. The computing device 110 may provide the image to the HWD 150 for rendering. The image of the space of the artificial reality corresponding to the user’s view can be presented to the user.

In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the computing device 110 may be performed by the HWD 150, and/or some of the functionality of the HWD 150 may be performed by the computing device 110. In some embodiments, the computing device 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155 (e.g., sensors 155A, 155B) including eye trackers and hand trackers for instance, a communication interface 165 (e.g., communication interface 165A, 165B), an electronic display 175, and a processor 170 (e.g., processor 170A, 170B). These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, hand trackers, eye trackers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors 155 may also include eye trackers with electronic components or a combination of electronic components and software components that determine a gaze direction of the user of the HWD 150. In other embodiments, the eye trackers may be a component separate from sensors 155. In some embodiments, the HWD 150, the computing device 110 or a combination may incorporate the gaze direction of the user of the HWD 150 to generate image data for artificial reality. In some embodiments, the eye trackers (as part of the sensors 155, for instance) include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is -10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers as part of the sensors 155. In some embodiments, a user of the HWD 150 is prompted to enable or disable the eye trackers as part of the sensor 155 configuration.

In some embodiments, the sensors 155 include the hand tracker, which includes an electronic component or a combination of an electronic component and a software component that tracks a hand of the user. In other embodiments, the hand tracker may be a component separate from sensors 155.In some embodiments, the hand tracker includes or is coupled to an imaging sensor (e.g., camera) and an image processor that can detect a shape, a location and/or an orientation of the hand. The hand tracker may generate hand tracking measurements indicating the detected shape, location and/or orientation of the hand.

In some embodiments, the communication interfaces 165 (e.g., communication interface 165A, 165B) of the corresponding HWDs 150 (e.g., HWD 150A, 150B) and/or communication interfaces 115 (e.g., communication interface 115A, 115B) of the corresponding computing devices (e.g., computing device 110A, 110B) include an electronic component or a combination of an electronic component and a software component that is used for communication.

The communication interface 165 may communicate with a communication interface 115 of the computing device 110 through an intralink communication link 125 (e.g., communication link 125A, 125B). The communication interface 165 may transmit to the computing device 110 sensor measurements indicating the determined location of the HWD 150, orientation of the HWD 150, the determined gaze direction of the user, and/or hand tracking measurements. For example, the computing device 110 may receive sensor measurements indicating location and the gaze direction of the user of the HWD 150 and/or hand tracking measurements and provide the image data to the HWD 150 for presentation of the artificial reality, for example, through the wireless link 125 (e.g., intralink). For example, the communication interface 115 may transmit to the HWD 150 data describing an image to be rendered. The communication interface 165 may receive from the computing device 110 sensor measurements indicating or corresponding to an image to be rendered. In some embodiments, the HWD 150 may communicate with the access point 105.

Similarly, the communication interface 115 (e.g., communication interface 115A, 115B) of the computing devices 110 may communicate with the access point 105 through a communication link 102 (e.g., communication link 102A, 102B). In certain embodiments, the computing device 110 may be considered a soft access point (e.g., a hotspot device). Through the communication link 102 (e.g., interlink), the communication interface 115 may transmit and receive from the access point 105 AR/VR content. The communication interface 115 of the computing device 110 may also communicate with communication interface 115 of a different computing device 110 through communication link 185. As described herein, the communication interface 115 may be a counterpart component to the communication interface 165 to communicate with a communication interface 115 of the computing device 110 through a communication link (e.g., USB cable, a wireless link).

The communication interfaces 115 and 165 may receive and/or transmit information indicating a communication link (e.g., channel, timing) between the devices (e.g., between the computing devices 110A and 110B across communication link 185, between the HWD 150A and computing device 110A across communication link 125). According to the information indicating the communication link, the devices may coordinate or schedule operations to avoid interference or collisions.

The communication link may be a wireless link, a wired link, or both. In some embodiments, the communication interface 165/115 includes or is embodied as a transceiver for transmitting and receiving data through a wireless link. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the computing device 110 and the head wearable display (HWD) 150A are implemented on a single system, the communication interface 165 may communicate with the computing device 110 through a bus connection or a conductive trace.

Using the communication interface, the computing device 110 (or HWD 150, or AP 105) may coordinate operations on links 102, 185 or 125 to reduce collisions or interferences by scheduling communication. For example, the computing device 110 may coordinate communication between the computing device 110 and the HWD 150 using communication link 125. Data (e.g., a traffic stream) may flow in a direction on link 125. For example, the computing device 110 may communicate using a downlink (DL) communication to the HWD 150 and the HWD 150 may communicate using an uplink (UL) communication to the computing device 110. In some implementations, the computing device 110 may transmit a beacon frame periodically to announce/advertise a presence of a wireless link between the computing device 110 and the HWD 150 (or between HWDs 150A and 150B). In an implementation, the HWD 150 may monitor for or receive the beacon frame from the computing device 110, and can schedule communication with the HWD 150 (e.g., using the information in the beacon frame, such as an offset value) to avoid collision or interference with communication between the computing device 110 and/or HWD 150 and other devices.

In some embodiments, the processor 170 may include an image renderer, for instance, which includes an electronic component or a combination of an electronic component and a software component that generates one or more images for display, for example, according to a change in view of the space of the artificial reality. In some embodiments, the image renderer is implemented as processor 170 (or a graphical processing unit (GPU), one or more central processing unit (CPUs), or a combination of them) that executes instructions to perform various functions described herein. In other embodiments, the image renderer may be a component separate from processor 170. The image renderer may receive, through the communication interface 165, data describing an image to be rendered, and render the image through the electronic display 175. In some embodiments, the data from the computing device 110 may be encoded, and the image renderer may decode the data to generate and render the image. In one aspect, the image renderer receives the encoded image from the computing device 110, and decodes the encoded image, such that a communication bandwidth between the computing device 110 and the HWD 150 can be reduced.

In some embodiments, the image renderer receives, from the computing device, 110 additional data including object information indicating virtual objects in the artificial reality space and depth information indicating depth (or distances from the HWD 150) of the virtual objects. Accordingly, the image renderer may receive from the computing device 110 object information and/or depth information. The image renderer may also receive updated sensor measurements from the sensors 155. The process of detecting, by the HWD 150, the location and the orientation of the HWD 150 and/or the gaze direction of the user wearing the HWD 150, and generating and transmitting, by the computing device 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer may generate a small portion (e.g., 10 %) of an image corresponding to an updated view within the artificial reality according to the updated sensor measurements, and append the portion to the image in the image data from the computing device 110 through reprojection. The image renderer may perform shading and/or blending on the appended edges. Hence, without recreating the image of the artificial reality according to the updated sensor measurements, the image renderer can generate the image of the artificial reality.

In other implementations, the image renderer generates one or more images through a shading process and a reprojection process when an image from the computing device 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user’s eyes. In one aspect, the electronic display 175 emits or projects light towards the user’s eyes according to image generated by the processor 170 (e.g., image renderer).

In some embodiments, the HWD 150 may include a lens to allow the user to see the display 175 in a close proximity. The lens may be a mechanical component that alters received light from the electronic display 175. The lens may magnify the light from the electronic display 175, and correct for optical error associated with the light. The lens may be a Fresnel lens, a convex lens, a concave lens, a filter, or any suitable optical component that alters the light from the electronic display 175. Through the lens, light from the electronic display 175 can reach the pupils, such that the user can see the image displayed by the electronic display 175, despite the close proximity of the electronic display 175 to the eyes.

In some embodiments, the processor 170 performs compensation to compensate for any distortions or aberrations. In some embodiments, a compensator may be a device separate from the processor 170. The compensator includes an electronic component or a combination of an electronic component and a software component that performs compensation. In one aspect, the lens introduces optical aberrations such as a chromatic aberration, a pin-cushion distortion, barrel distortion, etc. The compensator may determine a compensation (e.g., predistortion) to apply to the image to be rendered from the image renderer to compensate for the distortions caused by the lens, and apply the determined compensation to the image from the image renderer. The compensator may provide the predistorted image to the electronic display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a communication interface 115, a processor 118, and a content provider 130 (e.g., content provider 130A, 130B). These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view.

The processors 118, 170 includes or is embodied as one or more central processing units, graphics processing units, image processors, or any processors for generating images of the artificial reality . In some embodiments, the processors 118, 170 may configure or cause the communication interfaces 115, 165 to toggle, transition, cycle or switch between a sleep mode and a wake up mode. In the wake up mode, the processor 118 may enable the communication interface 115 and the processor 170 may enable the communication interface 165, such that the communication interfaces 115, 165 may exchange data. In the sleep mode, the processor 118 may disable the wireless interface 115 and the processor 170 may disable (e.g., may implement low power or reduced operation in) the communication interface 165, such that the communication interfaces 115, 165 may not consume power, or may reduce power consumption.

The processors 118, 170 may schedule the communication interfaces 115, 165 to switch between the sleep mode and the wake up mode periodically every frame time (e.g., 11 ms or 16 ms). For example, the communication interfaces 115, 165 may operate in the wake up mode for 2 ms of the frame time, and the communication interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced or minimized.

In some embodiments, the processors 118, 170 may configure or cause the communication interfaces 115, 165 to resume communication based on stored information indicating communication between the computing device 110 and the HWD 150. In the wake up mode, the processors 118, 170 may generate and store information (e.g., channel, timing) of the communication between the computing device 110 and the HWD 150. The processors 118, 170 may schedule the communication interfaces 115, 165 to enter a subsequent wake up mode according to timing of the previous communication indicated by the stored information. For example, the communication interfaces 115, 165 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118, 170 may configure or cause the wireless interfaces 115, 165 to enter the sleep mode. When entering the wake up mode, the processors 118, 170 may cause or configure the communication interfaces 115, 165 to resume communication via the channel or frequency band of the previous communication indicated by the stored information. Accordingly, the communication interfaces 115, in 165 entering the wake up mode from the sleep mode may resume communication, while bypassing a scan procedure to search for available channels and/or performing handshake or authentication. Bypassing the scan procedure allows extension of a duration of the communication interfaces 115, 165 operating in the sleep mode, such that the computing device 110 and the HWD 150 can reduce power consumption.

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake up mode. Accordingly, multiple computing devices 110 and HWDs 150 in proximity (e.g., within 20 ft) may coexist and operate with reduced interference.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space. The content provider 130 may encode the image data describing the image, and can transmit the encoded data to the HWD 150. In some embodiments, the content provider generates and provides the image data to the HWD 150 periodically (e.g., every 11 ms or 16 ms).

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

In some embodiments, a scheduler 118 (e.g., scheduler 118A of the computing device 110A and/or scheduler 118B of the computing device 110B) may request R-TWT to transmit latency sensitive traffic using P2P communication. The AP 105 and scheduler 118 of the computing devices 110 may negotiate (e.g., perform a handshake process) and may establish a membership of a restricted TWT schedule. In some embodiments, when the AP 105 and the scheduler 118 are negotiating, the AP 105 may be considered a restricted TWT scheduling AP and the computing devices 110 may be considered a restricted TWT scheduled STA.

In some embodiments, the HWD 150 may request to send P2P traffic to the computing device 110. Accordingly, the HWD 150 may be considered the TWT requesting STA (e.g., the TWT STA that requests the TWT agreement), and the computing device 110 may be considered TWT responding STA (e.g., the TWT STA that respond to the TWT request). The communication link 125 between the computing devices 110 and the HWDs 150 may be a P2P link (e.g., a link used for transmission between two non-AP devices). The communication link 102 between the computing devices 110 and the AP 105 may be any channel or other type of link. In some configurations, the HWD 150 may move/become out of range from the access point 105. In other embodiments, the computing device 110 may request to send P2P traffic to the HWD 150 such that the computing device 110 is considered the TWT requesting STA and the HWD 150 is the TWT responding STA.

The schedulers 118 of the computing devices 110 may schedule communication between the computing device(s) 110 and the HWD(s) 150 with the AP 105 such that the communication between the computing device(s) 110 and HWD(s) 150 is protected. The computing device(s) 110 may initiate such protected P2P communication with the HWD(s) 150 by indicating, to the AP 105, that the computing device(s) 110wish to schedule P2P communication in R-TWT SPs. The scheduler 118 of the computing device(s) may schedule (or negotiate) the requested R-TWT SP(s). The scheduler 118 of the computing device(s) may also indicate if the SP(s) are requested only for P2P communication (as compared to mixed P2P communication and non-P2P communication).

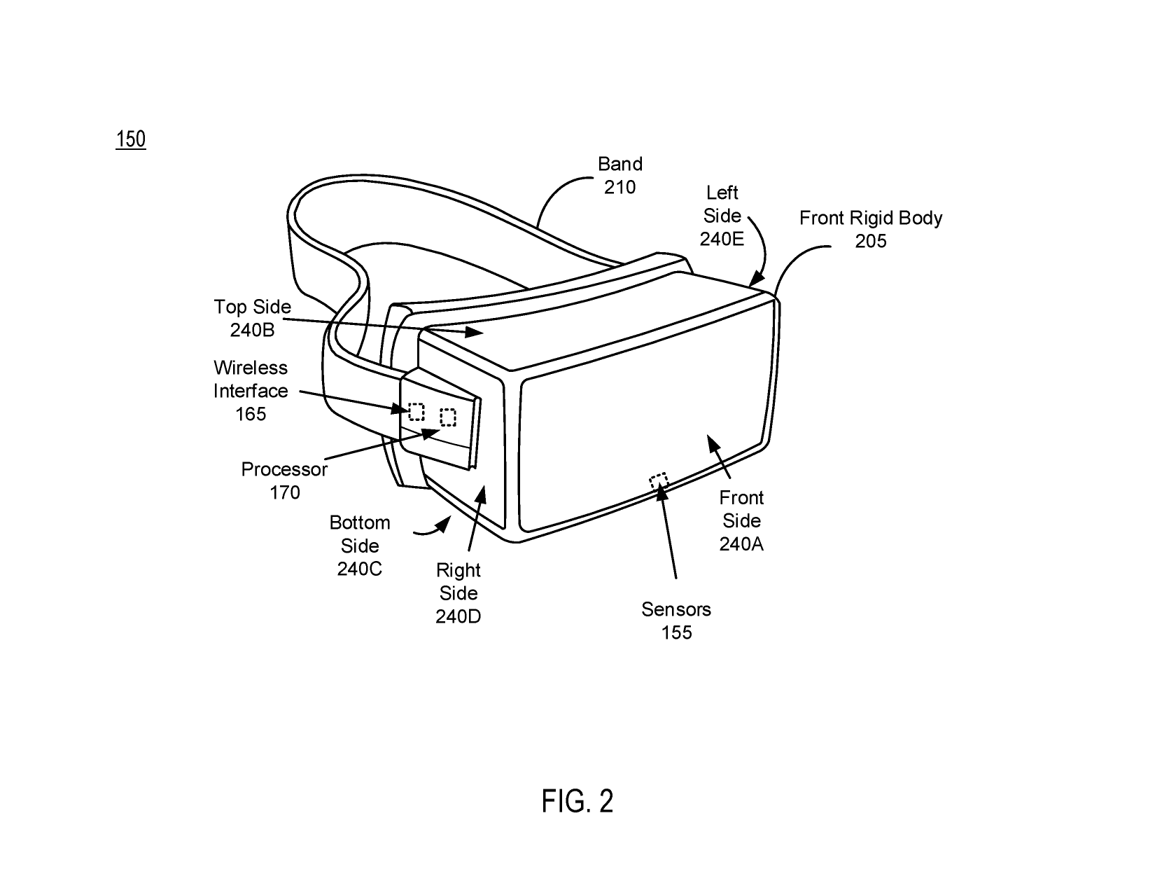

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not visible to the user. In other embodiments, the HWD 150 has a different configuration than shown in FIG. 2. For example, the processor 170, the eye trackers, and/or the sensors 155 may be in different locations than shown in FIG. 2.

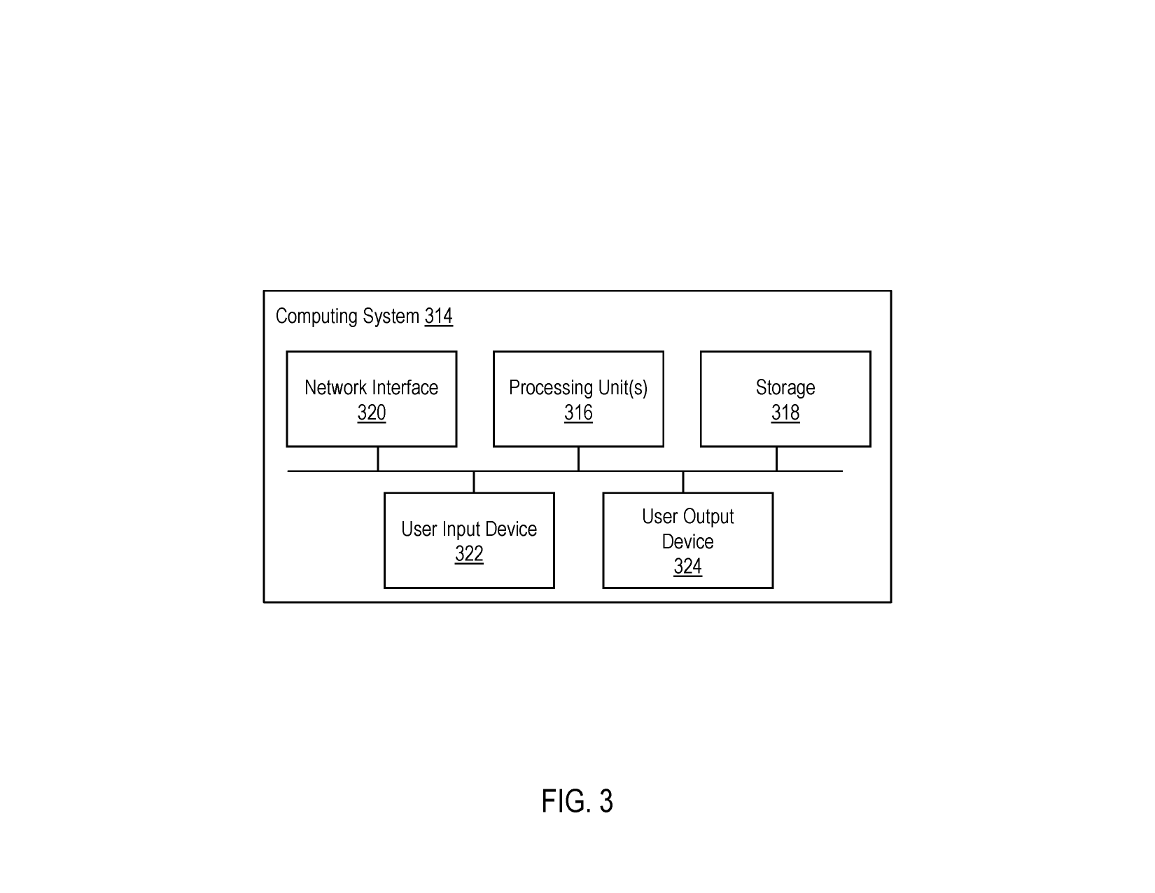

Various operations described herein can be implemented on computer systems. FIG. 3 shows a block diagram of a representative computing system 314 usable to implement the present disclosure. In some embodiments, the computing device 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

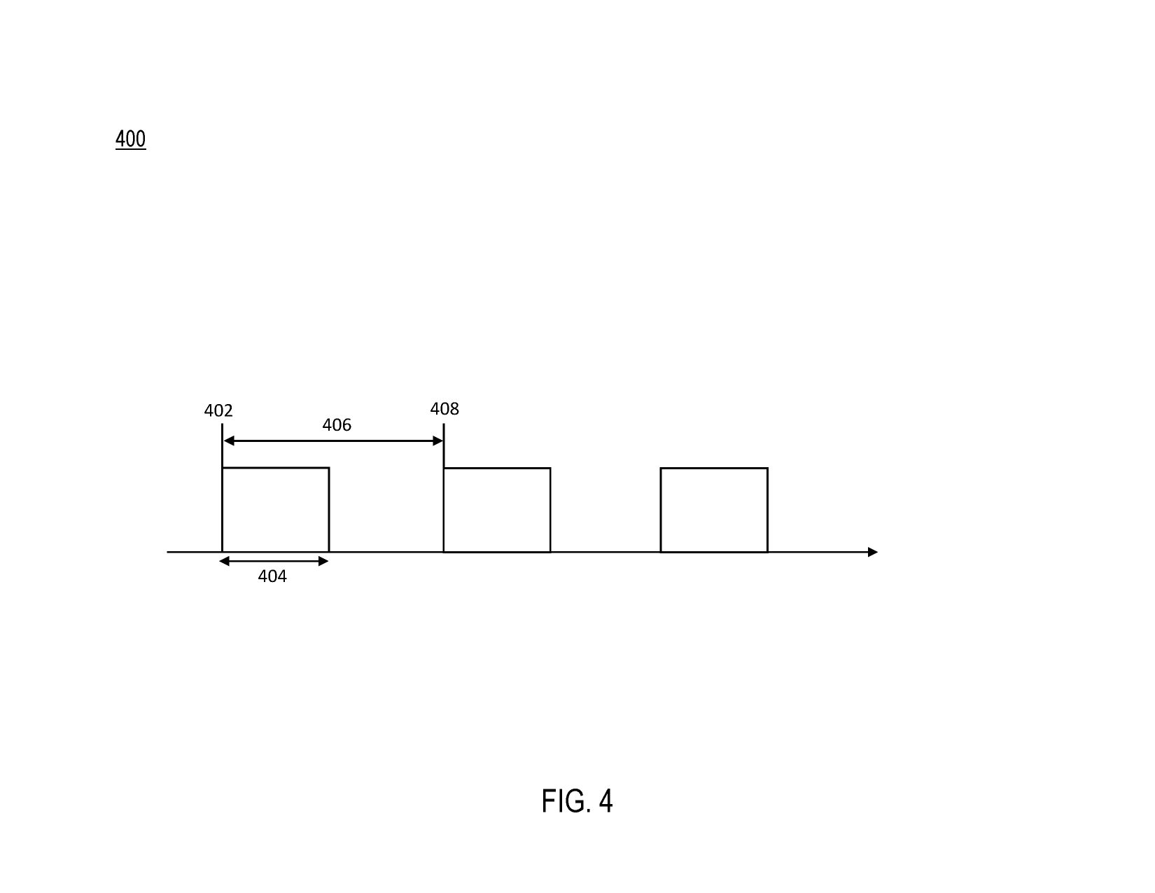

FIGS. 1-2 illustrate devices that communicate traffic streams some of which may be latency sensitive (e.g., those carrying periodic AR/VR information/content). As described herein, the periodic operation of TWT benefits communication of periodic traffic (e.g., latency sensitive traffic) by predictably communicating the periodic traffic. FIG. 4 is a timing diagram 400 showing a wake-up/sleep schedule of a computing device utilizing TWT, according to an example implementation of the present disclosure. The TWT start time is indicated by the computing device 110 (e.g., a portion of its relevant modules/circuitry) waking up at 402. The computing device 110 may wake up for a duration 404 defined by a SP. After the SP duration 404, the computing device 110 may enter a sleep state until the next TWT start time at 408. The interval of time between TWT start time 402 and TWT start time 408 may be considered the SP interval 406.

A TWT schedule may be communicated and/or negotiated using broadcast TWT (B-TWT) and/or individual TWT (I-TWT) signaling. In some embodiments, to signal I-TWT, TWT schedule information may be communicated to particular (individual) devices using a mode such as a Network Allocation Vector (NAV) to protect the medium access of TWT SPs. In contrast, to signal B-TWT, in some embodiments, a device (such as AP 105) may schedule TWT SPs with other devices (e.g., computing devices 110 and/or HWDs 150) and may share schedule information in beacon frames and/or probe response frames. Sharing schedule information using B-TWT may reduce overhead (e.g., negotiation overhead) as compared to the overhead used when sharing information using I-TWT.

The TWT mechanism may also be used in P2P communication. For example, TWT may be defined for tunneled direct link setup (TDLS) pairs (e.g., non-AP STAs), soft APs (such as computing devices 110) and STAs (such as HWD 150), and/or P2P group owners (GO) and group clients (GC). For instance, a TDLS pair of devices (e.g., HWD 150 and computing device 110) can request TWT membership for its latency sensitive traffic over a channel. In another example, a group owner (GO), such as a computing device 110, may request TWT membership for latency sensitive traffic over the P2P link.

When P2P communication is established, various channel access rules may govern the P2P communication. An AP assisted P2P trigger frame sequence may reduce the contention/collision associated with TWT (or R-TWT) in P2P communication. Accordingly, a P2P model where a P2P STA (e.g., a HWD 150) is not associated with an infra-basic service set (BSS) AP, may improve P2P communication. Without AP’s assistance or coordination, a transmission over the P2P link may collide with another transmission in the BSS. In some embodiments, a reverse direction protocol (RDP) may be enabled for P2P communication. During RDP, when a transmitting STA has obtained a transmit opportunity (TXOP), the transmitting STA may grant permission for the receiving STA to transmit information back to the transmitting STA during the same TXOP. Accordingly, if a TWT setup allows P2P transmission and indicates RDP, the P2P communication can be performed after a triggered frame sequence (e.g., a reverse direction frame exchange). In other embodiments, other protocols may be enabled for P2P communication. In some embodiments, trigger-enabled TWT can reduce the medium contention and/or collisions between UL and DL transmissions. The trigger-enabled TWT may be indicated using a TWT information element (IE).

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

In one aspect, it would be beneficial to enable a first device, such as a station (STA), to express latency-related needs for a traffic flow in a wireless local area network (WLAN), for example when communicating with a second device, such as an access point (AP), that operates in a power save mode. For example, the STA may be engaged in latency-sensitive activities, such as streaming or interactive applications, and may require the AP to remain awake during a particular time period to support timely delivery of data. However, signaling mechanisms may not allow the STA to indicate that certain traffic flows are sensitive to delays caused by the AP’s power saving behavior, making it difficult to coordinate wakefulness between the devices.

To address these problems and/or benefits, disclosed herein are systems, devices, and methods for generating and transmitting a frame that includes a set of quality of service (QoS) parameters of a traffic flow, where the QoS parameters include one or more fields indicating a request for the AP to be available during a time period associated with the traffic flow. In some embodiments, the one or more fields may reflect latency sensitivity and be set by the STA to prompt the AP to adjust its power save behavior accordingly. This allows for enhanced responsiveness and latency performance in WLAN environments without requiring changes to the underlying power save mechanisms of the second device.

In some embodiments, a STA may be any device that operates in a WLAN. The STA may include one or more processors and a transceiver. The one or more processors may control various wireless communication operations of the STA. The transceiver may transmit and receive frames over the WLAN. In some implementations, the STA may be a non-AP STA, such as a mobile phone, tablet, laptop, wearable device, head-mounted display (HMD), or other client device configured to initiate and maintain wireless connections with an AP. In some implementations, the STA may be a device that supports various IEEE 802.11 standards, such as 802.11ax or 802.11be, and may participate in uplink or downlink transmissions within a basic service set (BSS) managed by the AP. The STA may support power save mechanisms and QoS features, including those related to latency sensitivity of specific traffic flows.

In some embodiments, the STA may generate a first frame including a set of QoS parameters of a traffic flow of the STA in the WLAN. The QoS parameters may be included in a QoS information element (e.g., QoS IE), or another suitable format for communicating traffic characteristics in the WLAN. The traffic flow may correspond to a stream or session involving voice, video, gaming, or another latency-sensitive application. The set of QoS parameters may include a first field relating to latency of the traffic flow. For example, the first field may be a “low latency indication” field or a “power save accommodation” field that conveys latency characteristics of the traffic flow. The STA may determine values for the first field based on the latency sensitivity or delay tolerance of the associated traffic flow. The STA may include the first field in the QoS parameters in order to inform a second device, such as an AP, about expected delay sensitivity, and potentially influence how the AP handles the traffic flow during power save operations.

In some embodiments, the QoS parameters included in the first frame may include a first field that is a bit indicating whether the traffic flow is sensitive to delays due to a power save mechanism of the AP. For example, this bit may be set to a first value (e.g., 1) to indicate that the traffic flow is sensitive to such delays, and may be set to a second value (e.g., 0) to indicate that the traffic flow is not sensitive. This bit-level indication can enable the AP to make informed power save decisions that account for the latency requirements of the traffic flow, thereby improving responsiveness for delay-sensitive communications without unnecessarily increasing power usage.

In some embodiments, the first field included in the set of QoS parameters may indicate a level of latency sensitivity of the traffic flow among a plurality of levels of latency sensitivity of traffic flows. For example, the first field may represent the latency sensitivity using a relative scale, such as a 2-bit encoding supporting four levels (e.g., 1 to 4) or a 3-bit encoding supporting eight levels (e.g., 1 to 8). Each level may correspond to a respective category of threshold of acceptable delay for the traffic flow, allowing the AP to interpret and respond appropriately to the latency needs of the STA. This allows more granular and adaptive control over power save behavior and traffic handling based on the sensitivity of individual traffic flows.

In some embodiments, the STA may set the first field in the set of QoS parameters to indicate (e.g., to the AP) a request for availability of the AP during a time period associated with the traffic flow. The request may be made by assigning a particular value or setting to the first field that conveys the STA’s need for the AP to remain available (e.g., not in a sleep or power save state) during the relevant time period. By embedding this indication in a standardized field (e.g., a low latency indication or power save accommodation field) of a QoS information element, the STA can signal its latency expectations for the traffic flow while maintaining compatibility with existing WLAN signaling mechanisms. This allows the AP to receive and interpret the latency needs of the STA and determine whether and how to adjust its availability accordingly.

In some embodiments, the request for the availability of the AP during the time period may be a request for adjusting a power save schedule so that the AP remains awake during the time period. For example, the STA may determine that a traffic flow is sensitive to delays introduced by power save operations, and accordingly set the first field in the QoS parameters to signal to the AP that the STA prefers or requires the AP to avoid entering a low-power or sleep state during the relevant time window. In this manner, the AP may interpret the request as a directive to modify or override its existing power save behavior, such as adjusting its sleep/wake cycles, to remain available for communication with the STA throughout the specified period. This supports latency-sensitive applications by reducing response time variability due to the AP’s power management behavior.

In some embodiments, the STA may wirelessly transmit, via a transceiver to the AP, the first frame. The first frame may include the set of QoS parameters described herein, including the first field relating to latency of the traffic flow. The transmission of the first frame enables the STA to convey its latency preferences or requirements to the AP, in a manner that supports scheduling coordination or power management decisions by the AP. This transmission may occur during an association process, a QoS negotiation procedure, or as part of a dynamic traffic update.

In some embodiments, the first frame generated by the STA may include a second field relating to one or more capabilities of the STA. For instance, the second field may be referred to as an “AP Power Save Support” field. The STA may set the second field to indicate that the STA supports operating with another device that performs a power save operation. For example, the STA may include a flag, bit value, or encoded parameter within the second field to explicitly identify compatibility with APs or peer devices that enter or exit power save modes. Including the second field in the first frame allows the STA to communicate its readiness to coordinate with the power management behavior of the AP, which may support more efficient link scheduling and energy savings during ongoing or future communication sessions.

In some embodiments, the first frame generated by the STA may include a third field relating to one or more capabilities of the STA. For example, the third field may be referred to as a “Low Latency Indication Support” field. The STA may set the third field to indicate that the STA supports the use of the first field relating to the latency of the traffic flow. This third field can serve as an indication that the STA is capable of signaling latency-related preferences or constraints using the corresponding QoS information element structure. By including this field, the STA provides the AP with advance notice that it is capable of and willing to engage in latency-sensitive communication coordination, enabling the AP to respond appropriately or enable enhanced scheduling features.

In some embodiments, the STA may receive, via the transceiver, a second frame from the AP. The second frame may include a set of QoS parameters, which may include a fourth field. The fourth field (e.g., referred to as “Low Latency Indication” or “Power Save Accommodation” field) may indicate whether the AP accepts the request for availability of the AP during the time period associated with the traffic flow. For instance, when the STA previously transmitted the first field to signal that the traffic flow requires low latency or coordination with power save behavior, the AP may include the fourth field in its response to explicitly confirm or deny such request. The fourth field may be used by the STA to determine whether the AP will accommodate the requested availability, such as by modifying or maintaining its power save schedule.

In some embodiments, in response to the fourth field indicating that the AP accepts the request for availability, the STA may be controlled to be awake during the time period associated with the traffic flow. For example, if the fourth field received from the AP confirms agreement to remain available (e.g., awake) during the indicated time period, the STA may adjust its power management behavior to remain active and avoid entering a sleep state during that time. This enables the STA to maintain communication with the AP and ensures timely data exchange for latency-sensitive traffic flows. The STA may use a local timer, scheduling logic, or coordination mechanism to remain in the awake state in alignment with the accepted schedule.

In some embodiments, in response to the fourth field indicating that the AP does not accept the request for availability, the STA may be controlled not to be awake during the time period associated with the traffic flow. For example, if the fourth field received in the second frame indicates that the AP will not remain available during the requested time period, the STA may determine that communication cannot be performed during that time and may enter or remain in a sleep state to conserve power. This decision may be made based on a control process implemented by the STA, which interprets the value of the fourth field to dynamically adapt its power management behavior in response to the power save capability or intent of the AP.

In some embodiments, each of the first frame and the second frame may include the QoS information element (e.g., QoS IE) that includes the latency indication field. The latency indication field in the first frame (e.g., the first field) and the latency indication field in the second frame (e.g., the fourth field) may share a common format and semantics, such that the STA and the AP can interpret the fields consistently. For example, the STA may include the latency indication field in the QoS IE of the STA to express a desired level of responsiveness from the AP (e.g., low latency preference), and the AP may include the same field in the AP to indicate whether it accepts or accommodates the request. In this manner, both devices can exchange latency sensitivity information in a unified format, prompting compatibility and reducing implementation complexity across different device types.

Embodiments in the present disclosure have at least the following advantages and benefits. Embodiments in the present disclosure can provide useful techniques for supporting low latency communication in WLANs, including Wi-Fi infrastructure and peer-to-peer (P2P) topologies, by enabling a first device (e.g., a STA) to indicate latency sensitivity of a traffic flow using a QoS information element (e.g., QoS IE). For instance, the STA may use a latency indication field (e.g., low latency indication or power save accommodation field) to request the availability of a second device (e.g., an AP) during a time period associated with the traffic flow. This allows the second device to adjust its power save schedule accordingly, improving responsiveness for latency-sensitive traffic without requiring changes to power save mechanisms. Second, the present disclosure can enable consistent and extendible signaling between the STA and the AP by using matching QoS IE formats in both request and response frames. The STA may include a latency indication field in its QoS IE, and the AP may respond using the same type of field to indicate whether the request is accepted. This structure allows interoperability across multiple device types and protocol versions and reduces implementation overhead by avoiding separate signaling paths or negotiation protocols for latency accommodation.

With the foregoing in mind, the figures and description below illustrate various non-limiting example embodiments of low latency traffic accommodation using QoS IEs. Other implementations and configurations may also be used in accordance with the present disclosure.

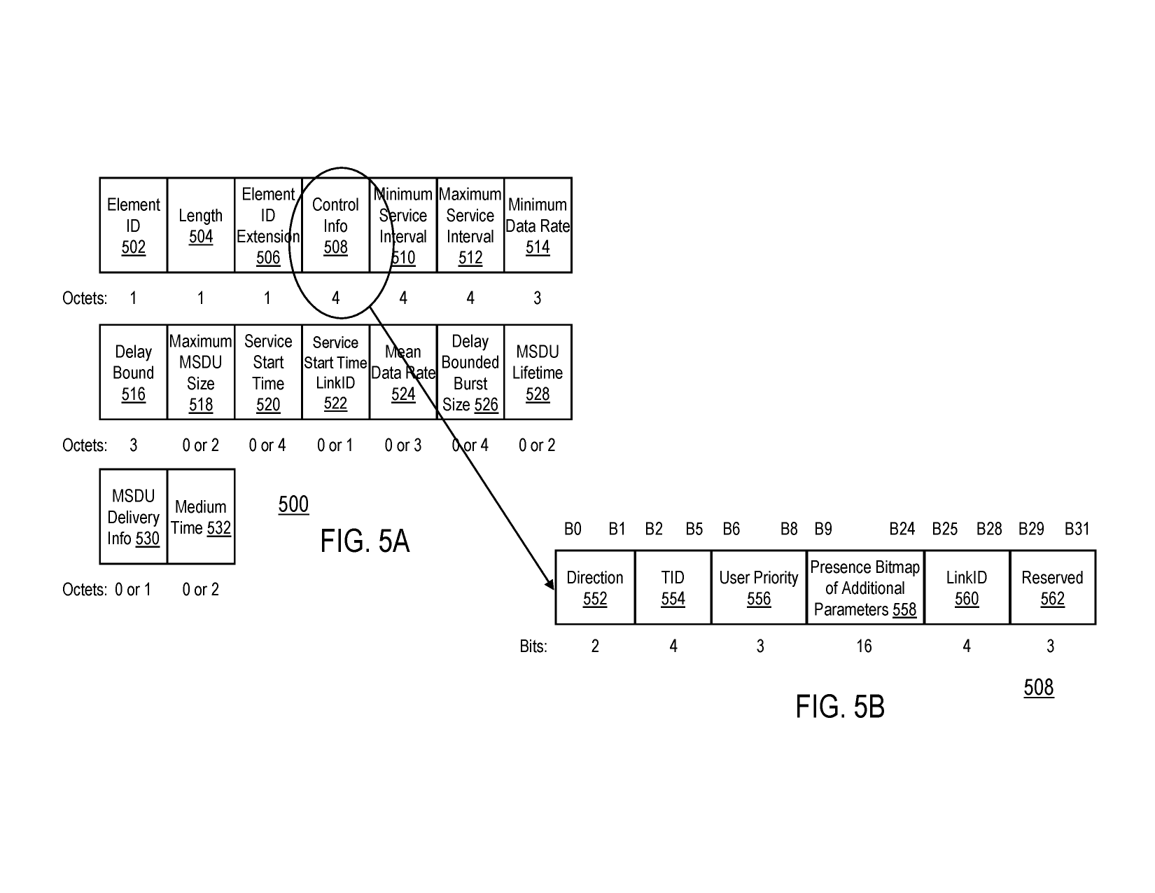

In some embodiments, an information element (IE) may deliver QoS parameters relating to latency of traffic flow. FIG. 5A is an example format of a QoS element field (or QoS information element (IE)) 500, according to an example implementation of the present disclosure. In some embodiments, the QoS IE 500 may be generated and/or transmitted by a first device (e.g., a STA). The QoS IE 500 may include fields of element ID 502, length 504, element ID extension 506, control information 508, minimum service interval 510, maximum service interval 512, minimum data rate 514, delay bound 516, maximum medium access control (MAC) service data unit (MSDU) size 518, service start time 520, service start time LinkID 522, mean data rate 524, delay bounded burst size 526, MSDU lifetime 528, MSDU delivery information 530, and/or medium time 532. FIG. 5B is an example format of the control information field 508, according to an example implementation of the present disclosure. The control information field 508 may include subfields of direction 552, TID 554, user priority 556, presence bitmap or additional parameters 558, link ID 560, and/or reserved 562 (which may be further specified in the future for various purposes).

In some embodiments, one or more bits in the reserved field 562 may be configured for low latency indication. For example, the reserved field 562 may be or include a bit indicating whether the traffic flow is sensitive to delays due to a power save mechanism of the AP. For example, one or more bits in the reserved field 562 may be set to a first value (e.g., 1) to indicate that the traffic flow is sensitive to such delays, and may be set to a second value (e.g., 0) to indicate that the traffic flow is not sensitive. In some embodiments, one or more bits in the reserved field 562 may indicate a level of latency sensitivity of the traffic flow among a plurality of levels of latency sensitivity of traffic flows. For example, one or more bits in the reserved field 562 may represent the latency sensitivity using a relative scale, such as a 2-bit encoding supporting four levels (e.g., 1 to 4) or a 3-bit encoding supporting eight levels (e.g., 1 to 8). Each level may correspond to a respective category of threshold of acceptable delay for the traffic flow, allowing the AP to interpret and respond appropriately to the latency needs of the STA. In some embodiments, one or more bits in the reserved field 562 may indicate a request for availability of the AP during a time period associated with the traffic flow. The request may be made by assigning a particular value or setting that conveys the STA’s need for the AP to remain available (e.g., not in a sleep or power save state) during the relevant time period.

The control information field 508 may include a field of “AP Power Save Support” (not shown) or configure the reserved field 562 therefor. One or more bits in the AP Power Save Support field may indicate that the STA supports operating with another device that performs a power save operation. For example, the AP Power Save Support field may include a flag, bit value, or encoded parameter to explicitly identify compatibility with access points or peer devices that enter or exit power save modes.

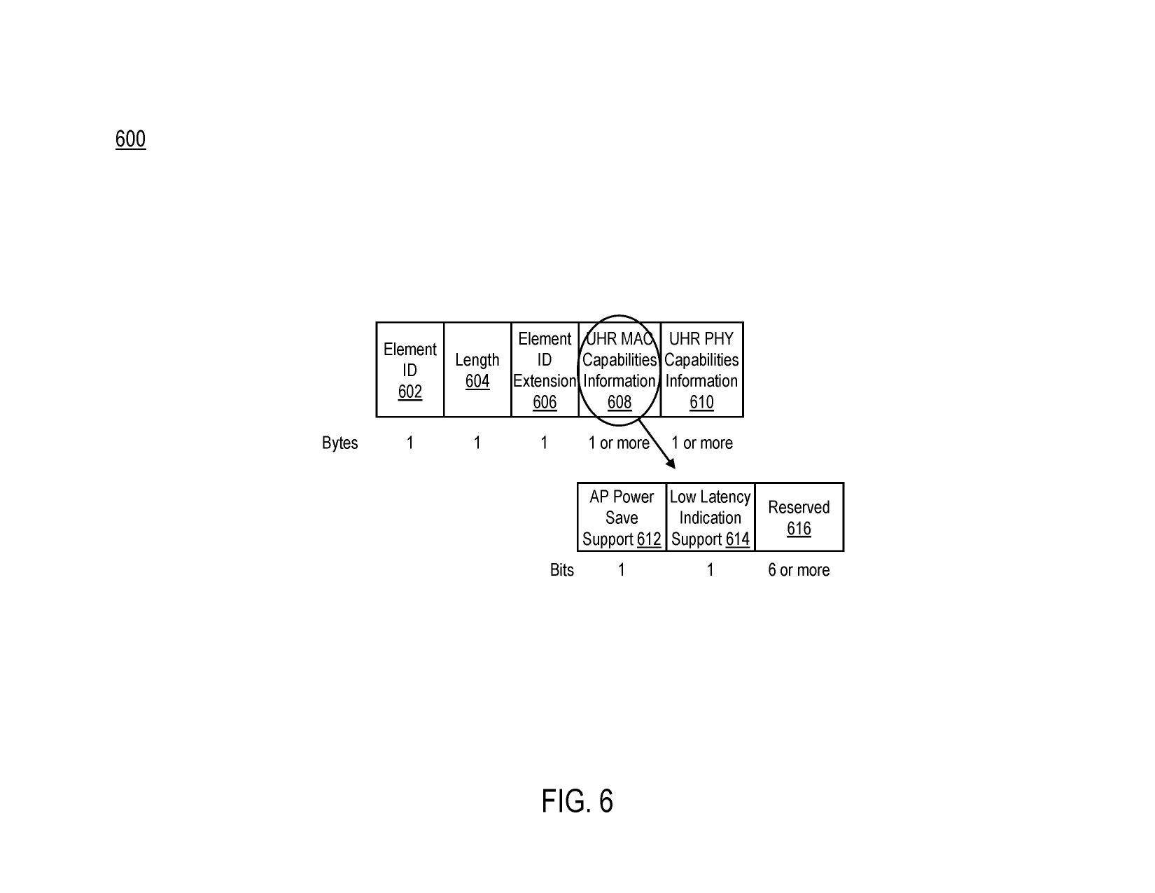

FIG. 6 is an example format of a capability element field 600, according to an example implementation of the present disclosure. In some embodiments, the capability element field 600 may be generated and/or transmitted by a first device (e.g., a STA). The capability element field 600 may include fields of element ID 602, length 604, element ID extension 606, ultra-high-rate (UHR) medium access control (MAC) capabilities information 608, and/or UHR PHY capabilities information 610. In some embodiments, the UHR MAC capabilities information field 608 may include the subfields of AP power save support 612, low latency indication support 614, and/or reserved 616.

In some embodiments, the low latency indication support field 614 may indicate that the STA supports the use of the QoS IE 500 relating to the latency of the traffic flow. The low latency indication support field 614 can serve as an indication that the STA is capable of signaling latency-related preferences or constraints using the corresponding QoS information element structure. By including the low latency indication support field 614, the STA provides an AP with advance notice that it is capable of and willing to engage in latency-sensitive communication coordination, enabling the AP to respond appropriately or enable enhanced scheduling features.

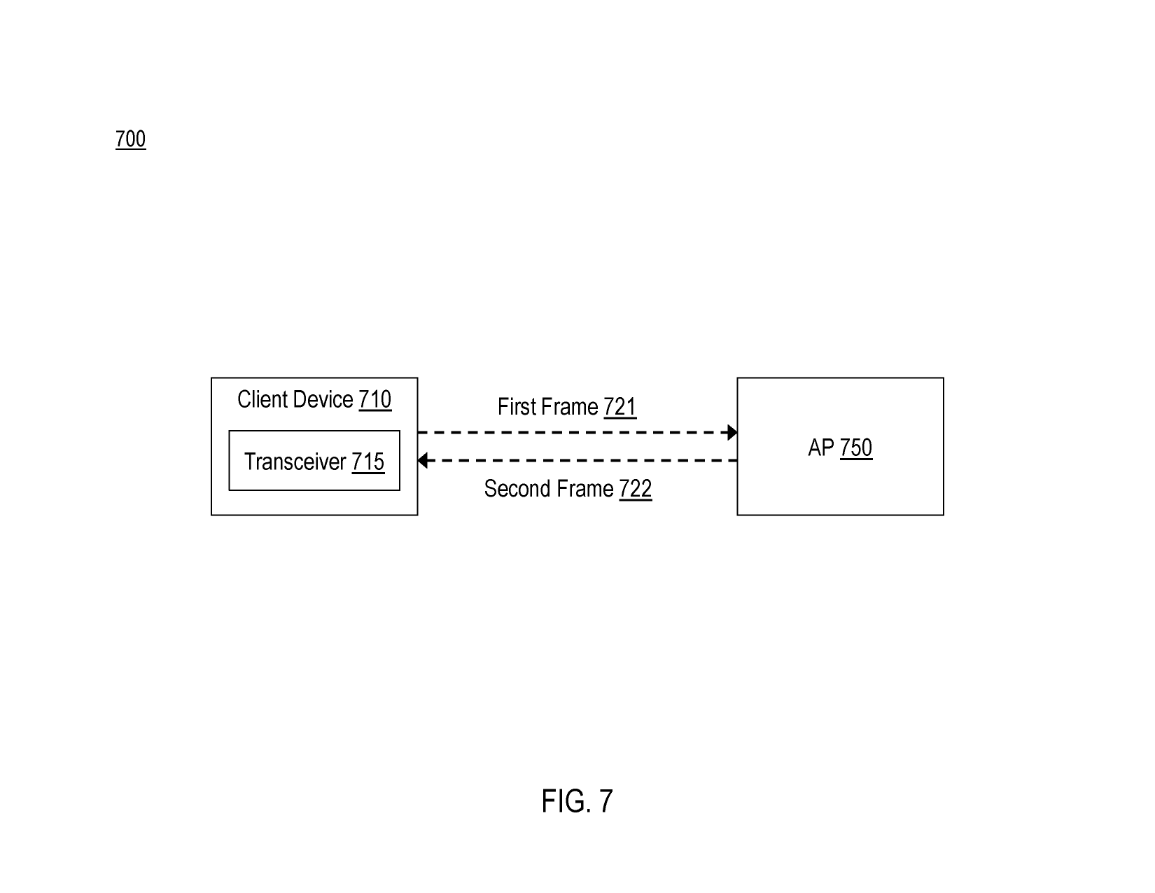

FIG. 7 is a block diagram of an example system environment 700 in which a client device 710 and an AP 750 communicate with each other data relating to QoS parameters, according to an example implementation of the present disclosure.

In some implementations, the client device 710 may be a non-AP STA, a HWD, or a computing device, such as a mobile phone, tablet, laptop, wearable device, head-mounted display (HMD), or other client device configured to initiate and maintain wireless connections with the AP 750. In some embodiments, the AP 750 may be a soft AP or a computing device in the WLAN. In some implementations, the client device 710 may be a device that supports various IEEE 802.11 standards, such as 802.11ax or 802.11be, and may participate in uplink or downlink transmissions within a basic service set (BSS) managed by the AP 750. The client device 710 may include one or more processors and a transceiver 715. The one or more processors may control various wireless communication operations of the client device 710, and the transceiver 715 may transmit and receive frames over the WLAN. The client device 710 may be configured to operate in a WLAN, supporting power save mechanisms and QoS features, including those related to latency sensitivity of specific traffic flows as described herein.

In some embodiments, the client device 710 may generate a first frame 721 including a set of QoS parameters of a traffic flow of the client device 710 in the WLAN. The QoS parameters may be included in a QoS information element (e.g., the QoS IE 500), or another suitable format for communicating traffic characteristics in the WLAN. The traffic flow may correspond to a stream or session involving voice, video, gaming, or another latency-sensitive application. The set of QoS parameters may include a first field relating to latency of the traffic flow. For example, the first field may be a “low latency indication” field or a “power save accommodation” field (e.g., the reserved field 562 configured therefor) that conveys latency characteristics of the traffic flow. The client device 710 may determine values for the first field based on the latency sensitivity or delay tolerance of the associated traffic flow. The client device 710 may include the first field in the QoS parameters in order to inform a second device, such as the AP 750, about expected delay sensitivity, and potentially influence how the AP 750 handles the traffic flow during power save operations.

In some embodiments, the QoS parameters included in the first frame 721 may include a first field (e.g., the reserved field 562) that is a bit indicating whether the traffic flow is sensitive to delays due to a power save mechanism of the AP 750. For example, this bit may be set to a first value (e.g., 1) to indicate that the traffic flow is sensitive to such delays, and may be set to a second value (e.g., 0) to indicate that the traffic flow is not sensitive. This bit-level indication can enable the AP 750 to make informed power save decisions that account for the latency requirements of the traffic flow, thereby improving responsiveness for delay-sensitive communications without unnecessarily increasing power usage.

In some embodiments, the first field included in the set of QoS parameters may indicate a level of latency sensitivity of the traffic flow among a plurality of levels of latency sensitivity of traffic flows. For example, the first field may represent the latency sensitivity using a relative scale, such as a 2-bit encoding supporting four levels (e.g., 1 to 4) or a 3-bit encoding supporting eight levels (e.g., 1 to 8). Each level may correspond to a respective category of threshold of acceptable delay for the traffic flow, allowing the AP 750 to interpret and respond appropriately to the latency needs of the client device 710. This allows more granular and adaptive control over power save behavior and traffic handling based on the sensitivity of individual traffic flows.

In some embodiments, the client device 710 may set the first field in the set of QoS parameters to indicate (e.g., to the AP 750) a request for availability of the AP 750 during a time period associated with the traffic flow. The request may be made by assigning a particular value or setting to the first field that conveys the need of the client device 710 for the AP 750 to remain available (e.g., not in a sleep or power save state) during the relevant time period. By embedding this indication in a standardized field (e.g., a low latency indication or power save accommodation field) of a QoS information element, the client device 710 can signal its latency expectations for the traffic flow while maintaining compatibility with existing WLAN signaling mechanisms. This allows the AP 750 to receive and interpret the latency needs of the client device 710 and determine whether and how to adjust its availability accordingly.

In some embodiments, the request for the availability of the AP 750 during the time period may be a request for adjusting a power save schedule so that the AP 750 remains awake during the time period. For example, the client device 710 may determine that a traffic flow is sensitive to delays introduced by power save operations, and accordingly set the first field in the QoS parameters to signal to the AP 750 that the client device 710 prefers or requires the AP 750 to avoid entering a low-power or sleep state during the relevant time window. In this manner, the AP 750 may interpret the request as a directive to modify or override its existing power save behavior, such as adjusting its sleep/wake cycles, to remain available for communication with the client device 710 throughout the specified period. This supports latency-sensitive applications by reducing response time variability due to power management behavior of the AP 750.

In some embodiments, the client device 710 may wirelessly transmit, via the transceiver 715 to the AP 750, the first frame 721. The first frame 721 may include the set of QoS parameters described herein, including the first field relating to latency of the traffic flow. The transmission of the first frame 721 enables the client device 710 to convey its latency preferences or requirements to the AP 750, in a manner that supports scheduling coordination or power management decisions by the AP 750. This transmission may occur during an association process, a QoS negotiation procedure, or as part of a dynamic traffic update.

In some embodiments, the first frame 721 generated by the client device 710 may include a second field relating to one or more capabilities of the client device 710. For instance, the second field may be referred to as an “AP Power Save Support” field. The client device 710 may set the second field to indicate that the client device 710 supports operating with another device that performs a power save operation. For example, the client device 710 may include a flag, bit value, or encoded parameter within the second field to explicitly identify compatibility with access points or peer devices that enter or exit power save modes. Including the second field in the first frame 721 allows the client device 710 to communicate its readiness to coordinate with the power management behavior of the AP 750, which may support more efficient link scheduling and energy savings during ongoing or future communication sessions.

In some embodiments, the first frame 721 generated by the client device 710 may include a third field (e.g., the low latency indication support field 614) relating to one or more capabilities of the client device 710. The client device 710 may set the third field to indicate that the client device 710 supports the use of the first field relating to the latency of the traffic flow. This third field can serve as an indication that the client device 710 is capable of signaling latency-related preferences or constraints using the corresponding QoS information element structure. By including this field, the client device 710 provides the AP 750 with advance notice that it is capable of and willing to engage in latency-sensitive communication coordination, enabling the AP 750 to respond appropriately or enable enhanced scheduling features.

In some embodiments, the client device 710 may receive, via the transceiver 715, a second frame 722 from the AP 750. The second frame 722 may include a set of QoS parameters, which may include a fourth field. The fourth field (e.g., referred to as “Low Latency Indication” or “Power Save Accommodation” field) may indicate whether the AP 750 accepts the request for availability of the AP 750 during the time period associated with the traffic flow. For instance, when the client device 710 previously transmitted the first field to signal that the traffic flow requires low latency or coordination with power save behavior, the AP 750 may include the fourth field in its response to explicitly confirm or deny such request. The fourth field may be used by the client device 710 to determine whether the AP 750 will accommodate the requested availability, such as by modifying or maintaining its power save schedule.

In some embodiments, in response to the fourth field indicating that the AP 750 accepts the request for availability, the client device 710 may be controlled to be awake during the time period associated with the traffic flow. For example, if the fourth field received from the AP 750 confirms agreement to remain available (e.g., awake) during the indicated time period, the client device 710 may adjust its power management behavior to remain active and avoid entering a sleep state during that time. This enables the client device 710 to maintain communication with the AP 750 and ensures timely data exchange for latency-sensitive traffic flows. The client device 710 may use a local timer, scheduling logic, or coordination mechanism to remain in the awake state in alignment with the accepted schedule.

In some embodiments, in response to the fourth field indicating that the AP 750 does not accept the request for availability, the client device 710 may be controlled not to be awake during the time period associated with the traffic flow. For example, if the fourth field received in the second frame indicates that the AP 750 will not remain available during the requested time period, the client device 710 may determine that communication cannot be performed during that time and may enter or remain in a sleep state to conserve power. This decision may be made based on a control process implemented by the client device 710, which interprets the value of the fourth field to dynamically adapt its power management behavior in response to the power save capability or intent of the AP 750.

In some embodiments, each of the first frame 721 and the second frame 722 may include the QoS information element (e.g., QoS IE) that includes the latency indication field. The latency indication field in the first frame 721 and the latency indication field in the second frame 722 may share a common format and semantics, such that the client device 710 and the AP 750 can interpret the fields consistently. For example, the client device 710 may include the latency indication field in the QoS IE of the client device 710 to express a desired level of responsiveness from the AP 750 (e.g., low latency preference), and the AP 750 may include the same field in the AP 750 to indicate whether it accepts or accommodates the request. In this manner, both devices can exchange latency sensitivity information in a unified format, prompting compatibility and reducing implementation complexity across different device types.

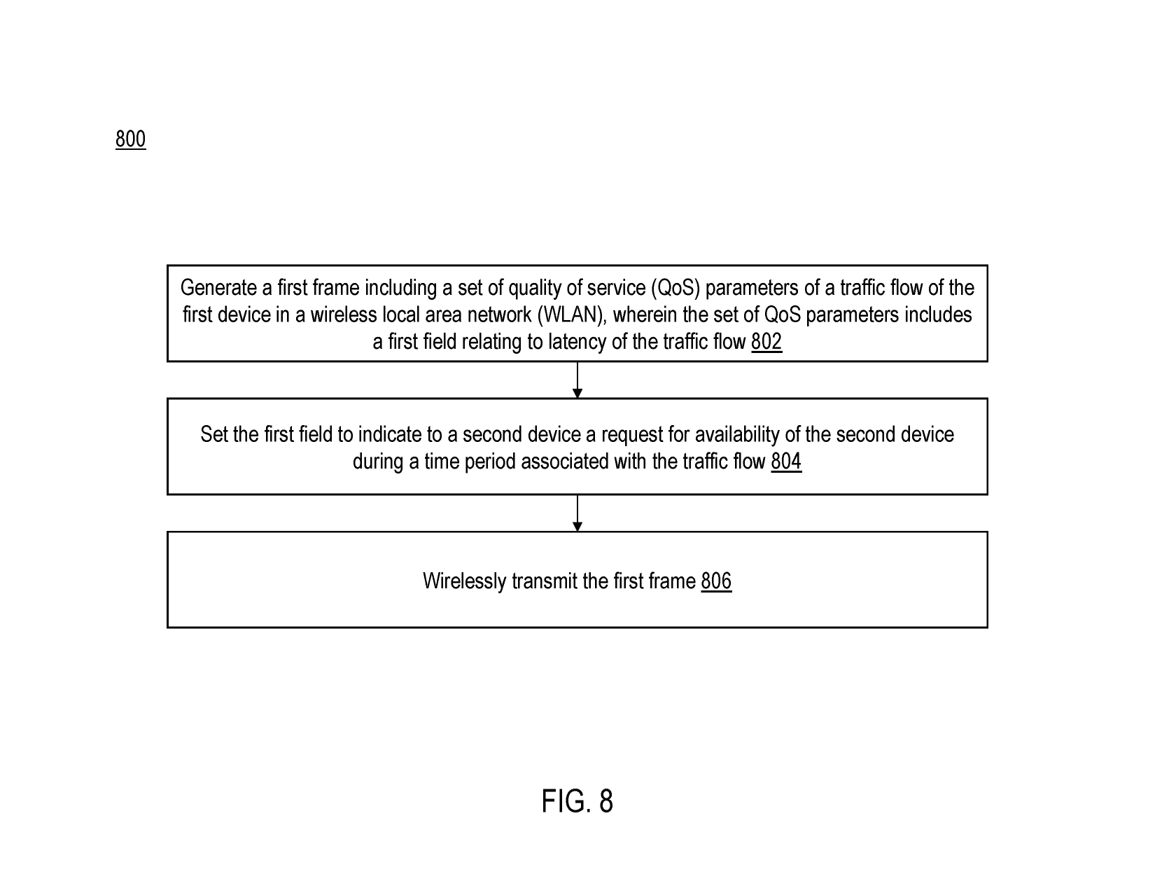

FIG. 8 is a flowchart showing a method 800 associated with QoS parameters relating to latency of traffic flow, according to an example implementation of the present disclosure. In some embodiments, the method 800 is performed by a first device (e.g., the client device 710, a STA, etc.) including one or more processors (e.g., processors 316) and a transceiver (e.g., the network interface 320, the transceiver 715, etc.). In some embodiments, the method 800 is performed by other entities. In some embodiments, the method 800 includes more, fewer, or different steps than shown in FIG. 8.

In some embodiments, the one or more processors of the first device may generate 802 a first frame (e.g., the first frame 721) including a set of QoS parameters of a traffic flow of the first device in a WLAN. The set of QoS parameters may include a first field (e.g., the reserved field 562 configured for low latency indication) relating to latency of the traffic flow. In some embodiments, the first field may be a bit indicating whether the traffic flow is sensitive to delays due to a power save mechanism of the second device. In some embodiments, the first field may indicate a level of latency sensitivity of the traffic flow among a plurality of levels of latency sensitivity of traffic flows.

In some embodiments, the one or more processors of the first device may set 804 the first field to indicate to a second device (e.g., the AP 750) a request for availability of the second device during a time period associated with the traffic flow. In some embodiments, the request for the availability of the second device during the time period may be a request for adjusting a power save schedule so that the second device remains awake during the time period.

In some embodiments, the one or more processors of the first device may wirelessly transmit 806, via a transceiver (e.g., the transceiver 715) to the second device, the first frame. In some embodiments, the first frame may include a second field relating to one or more capabilities of the first device. The method 800 may include setting the second field to indicate that the first device supports operating with another device that performs a power save operation. In some embodiments, the first frame may include a third field (e.g., the low latency indication support field 614) relating to one or more capabilities of the first device. The method 800 may include setting the third field to indicate that the first device supports the first field relating to the latency of the traffic flow.

In some embodiments, the method 800 may include receiving, via the transceiver from the second device, a second frame (e.g., the second frame 722) including a set of QoS parameters including a fourth field indicating whether the second device accepts the request of the availability of the second device during the time period associated with the traffic flow. In some embodiments, the method 800 may include, in response to the fourth field indicating that the second device accepts the request for the availability of the second device during the time period, controlling the first device to be awake during the time period. In some embodiments, the method 800 may include, in response to the fourth field indicating that the second device accepts the request of the availability of the second device during the time period, controlling the first device not to be awake during the time period.

In some embodiments, each of the first frame and the second frame may include a QoS IE that includes a latency indication field. Each of the first field and the fourth field may correspond to the latency indication field of a respective QoS IE of the first frame and the second frame.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first device comprising:
one or more processors configured to:
generate a first frame including a set of quality of service (QoS) parameters of a traffic flow of the first device in a wireless local area network (WLAN), wherein the set of QoS parameters includes a first field relating to latency of the traffic flow;
set the first field to indicate to a second device a request for availability of the second device during a time period associated with the traffic flow; and
wirelessly transmit, via a transceiver to the second device, the first frame.

2. The first device of claim 1, wherein
the first field is a bit indicating whether the traffic flow is sensitive to delays due to a power save mechanism of the second device.

3. The first device of claim 1, wherein
the first field indicates a level of latency sensitivity of the traffic flow among a plurality of levels of latency sensitivity of traffic flows.

4. The first device of claim 1, wherein
the request for the availability of the second device during the time period is a request for adjusting a power save schedule so that the second device remains awake during the time period.

5. The first device of claim 1, wherein
the first frame includes a second field relating to one or more capabilities of the first device, and
the one or more processors are configured to set the second field to indicate that the first device supports operating with another device that performs a power save operation.

6. The first device of claim 1, wherein
the first frame includes a third field relating to one or more capabilities of the first device, and
the one or more processors are configured to set the third field to indicate that the first device supports the first field relating to the latency of the traffic flow.

7. The first device of claim 1, wherein the one or more processors are configured to:
receive, via the transceiver from the second device, a second frame including a set of QoS parameters including a fourth field indicating whether the second device accepts the request of the availability of the second device during the time period associated with the traffic flow.

8. The first device of claim 7, wherein the one or more processors are configured to:
in response to the fourth field indicating that the second device accepts the request for the availability of the second device during the time period, control the first device to be awake during the time period.

9. The first device of claim 7, wherein the one or more processors are configured to:
in response to the fourth field indicating that the second device accepts the request of the availability of the second device during the time period, control the first device not to be awake during the time period.

10. The first device of claim 7, wherein
each of the first frame and the second frame includes a QoS information element (QoS IE) that includes a latency indication field, and
each of the first field and the fourth field corresponds to the latency indication field of a respective QoS IE of the first frame and the second frame.

11. A method comprising:
generating, by one or more processors of a first device, a first frame including a set of quality of service (QoS) parameters of a traffic flow of the first device in a wireless local area network (WLAN), wherein the set of QoS parameters includes a first field relating to latency of the traffic flow;
setting, by the one or more processors, the first field to indicate to a second device a request for availability of the second device during a time period associated with the traffic flow; and
wirelessly transmitting, via a transceiver to the second device, the first frame.

12. The method of claim 11, wherein
the first field is a bit indicating whether the traffic flow is sensitive to delays due to a power save mechanism of the second device.

13. The method of claim 11, wherein
the first field indicates a level of latency sensitivity of the traffic flow among a plurality of levels of latency sensitivity of traffic flows.

14. The method of claim 11, wherein
the request for the availability of the second device during the time period is a request for adjusting a power save schedule so that the second device remains awake during the time period.

15. The method of claim 11, wherein
the first frame includes a second field relating to one or more capabilities of the first device, and
the method further comprises setting the second field to indicate that the first device supports operating with another device that performs a power save operation.

16. The method of claim 11, wherein
the first frame includes a third field relating to one or more capabilities of the first device, and
the method further comprises setting the third field to indicate that the first device supports the first field relating to the latency of the traffic flow.

17. The method of claim 11, further comprising:
receiving, via the transceiver from the second device, a second frame including a set of QoS parameters including a fourth field indicating whether the second device accepts the request of the availability of the second device during the time period associated with the traffic flow.

18. The method of claim 17, further comprising:
in response to the fourth field indicating that the second device accepts the request for the availability of the second device during the time period, controlling the first device to be awake during the time period.

19. The method of claim 17, further comprising:
in response to the fourth field indicating that the second device accepts the request of the availability of the second device during the time period, controlling the first device not to be awake during the time period.

20. The method of claim 17, wherein
each of the first frame and the second frame includes a QoS information element (QoS IE) that includes a latency indication field, and
each of the first field and the fourth field corresponds to the latency indication field of a respective QoS IE of the first frame and the second frame.
